(19) United States
(12) Patent Application Publication
(10) Pub. No.: US 2002/0167229 A1
(43) Pub. Date: Nov. 14, 2002

(54) Method of handling faults and preventing damage on machine tools and production machines, and also robots

(76) Inventor: Werner Agne, Rothenbach (DE)

Correspondence Address: BAKER & BOTTS, 30 ROCKEFELLER PLAZA, NEW YORK, NY, 10112

(21) Appl. No.: 09/929,394

(22) Filed: Aug. 14, 2001

(30) Foreign Application Priority Data
May 11, 2001 (DE) 101 229 06.2

(51) Int. Cl. H02H 3/00

(52) U.S. Cl. 307/412

(57) ABSTRACT

The invention relates to a method of handling faults and preventing damage to or from machine tools, production machines, and robots, having individually driven machine elements. Process information is exchanged between the drives (A1-A6) via at least one data link (AB1, AB2, LB, Q), with the result that a drive braking function and/or a system standstill is initiated after detection of a faulty drive (A1-A6), and the actual values (G1, G2, of the faulty drive (A1-A6) are transmitted as nominal values to the faultlessly operating drives (A1-A6) involved.

### FIELD OF THE INVENTION

The invention relates to a method of handling faults and preventing damage to machine tools, production machines, and robots, hereinafter machines, which have individually driven rotating machine elements.

### BACKGROUND OF THE INVENTION

EP 0 687 395 B1 discloses a method of preventing damage on numerically controlled machines in the event of a power failure. It discloses how, in the event of a power failure, a supply voltage for at least one axis drive motor is obtained from the kinetic energy of at least one other axis drive motor to effect a position-controlled, programmed emergency return traverse.

EP 0 583 487 B1 discloses a method of braking the axis drives of numerically controlled machines optimally in terms of time and without deviating from their path. In these machines, emergency braking of the axis drives is provided for hazardous situations. If this emergency braking is triggered, the drives of the numerically controlled machine are braked linearly in the shortest time by the nominal rotational speed values being correspondingly prescribed. With time-optimal, path-maintaining braking it is intended to avoid collision of the tool with the workpiece or other objects when the machine deviates from the prescribed path.

If a malfunction of a drive occurs in a technical process, and the drive can no longer control its associated motor, the drive idles until it is at a standstill. Even when other related drives are brought to a system standstill, this generally takes place in an uncontrolled way. Consequently, material produced or transported, or even the involved machine itself, may be damaged by the uncontrolled running down of the faulty drive or other drives.

### SUMMARY OF THE INVENTION

The object of the present invention is to initiate a standstill of a system or subsystem (machine) in the event of a drive fault, and to prescribe actual values for the faulty drive that can still be acquired as nominal values to other drives involved. According to the present invention, this object is achieved in accordance with the following method:

First, an exchange of process information of an associated technical process via at least one data link;

Second, initiating a drive braking function and/or a system standstill after detection of a faulty drive, and including an impermissible drive state or an unwanted machine state; and

Third, transmitting, as nominal values to the faultlessly operating drives, actual values of the faulty drive or drive associated with a malfunction, which may be changed by at least one mathematical function according to process requirements.

The use of this method accomplishes the following:

the minimizing or avoidance of damage to the machine;

the minimizing or avoidance of product damage; and

shorter downtimes on account of shorter repair times.

These advantages lead to a greater availability of a fully operational system, and a reduced financial burden for the system operator in the event of a fault.

A preferred aspect of the present invention involves the use of a real-time communication link as the data link. A real-time communication link makes it possible for the remaining operational drives to synchronize themselves in real time with the faulty drive. Consequently, a faster synchronization of all the faultlessly operating drives with the faulty drive is possible, and also a faster response to changes in actual values of the faulty drive.

A further preferred aspect of the present invention involves the use of a real-time Ethernet as the real-time data link. Consequently, a standardized, universally usable bus protocol can be advantageously used, which moreover facilitates a high transmission capacity. The use of a real-time Ethernet also makes possible short bus cycles, and consequently a rapid detection of measuring parameters, which in turn makes possible a rapid correction of nominal value preselections.

The preferred application of the present invention is in machine tools, production machines, or robots having at least one individual drive in a coordinated technical process. A specific example of such a preferred application of the method of the present invention is in a printing machine, i.e. production machine, where in the event of a failure of a drive, paper build-ups and jams, as well as damage to the printing machine, are reduced or totally avoided.

### DRAWINGS

An exemplary embodiment of the invention is explained in more detail below and in the context of the drawings, in which:

FIG. 1 shows a structural overview of various interlinked drive groups; and

FIGS. 2 to 4 show actual and nominal values of a faulty drive, and also nominal values of involved drives.

### DETAILED DESCRIPTION OF THE INVENTION

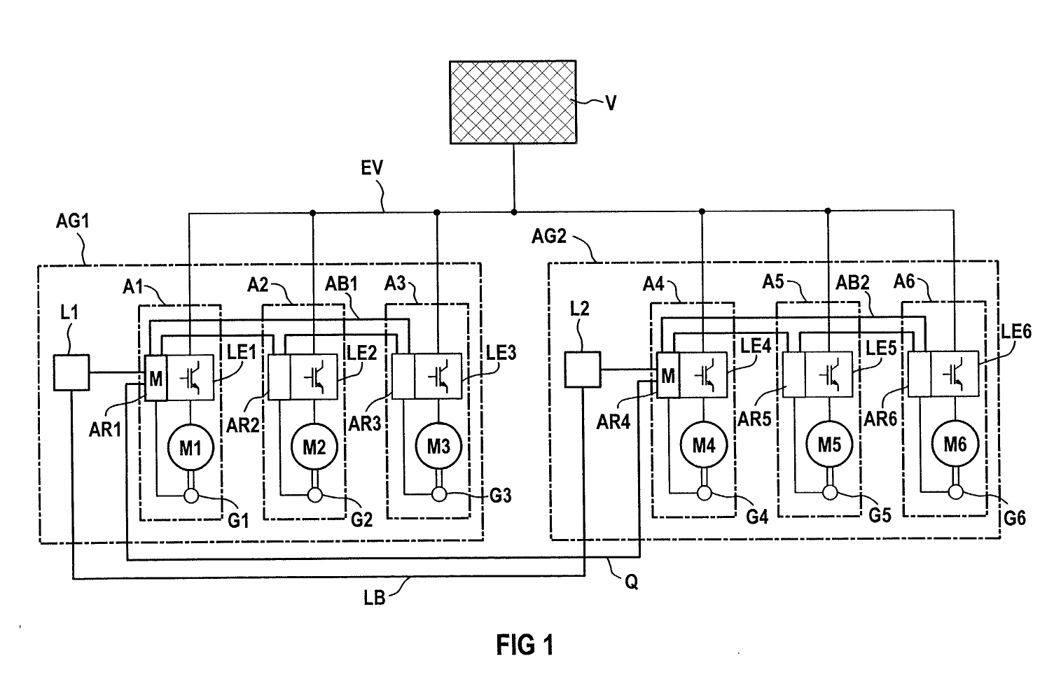

In FIG. 1, major components of a drive A1 to A6 are depicted in a rectangle with a broken outline. The drive comprises at least one motor M1 to M6, which is activated by a drive controller AR1 to AR6 via power electronics LE1 to LE6. This is identified by a symbol from power electronics, namely an IGBT circuit symbol (Insulated Gate Bipolar Transistor). Furthermore, each motor M1 to M6 has an associated sensor G1 to G6. The motor M1 to M6 is depicted by a large circle and the sensor G1 to G6 is depicted by a small circle in the drive A1 to A6.

The drive controllers AR1 to AR6 of a respective drive group AG1, AG2 are interlinked with one another in the form of a ring via data lines AB1, AB2. Two lines of the drive bus respectively lead into each drive controller AR1 to AR6. For the sake of overall clarity, only one data line AB1, AB2 of an annular data network is denoted in each case. Furthermore, a drive group AG1, AG2 is depicted in each case by a large rectangle provided with a broken outline, in which at least one drive A1 to A6 is located. Further networking structures, feasible in terms of data technology, are conceivable, for example, a star-shaped connection of the drive controllers AR1 to AR6. In each case, one drive controller AR1 to AR6 of a drive group AG1, AG2 has master functionality AR1, AR4. This is identified in FIG. 1 by the letter M and a more pronounced outline.

The data network AB1, AB2 close to the drive undertakes the synchronization of the drives A1 to A6 of a drive group AG1, AG2. A cross communication Q makes it possible for the drive controllers with master functionality AR1, AR4 to exchange data close to the drive, which are necessary for the mutual coordination of open-loop or closed-loop control actions.

For each drive controller with master functionality AR1, AR4, there is a master computer L1, L2, which performs a function with higher-level control over the drives. The master computers L1, L2 are connected to a master computer bus LB and can, for example, collect, evaluate and possibly display process data, and hence assume the function of a “human-machine interface”. All the data connections Q, LB, AB1, AB2 may be executed by a real-time data network, such as a real-time Ethernet.

The power electronics LE1 to LE6 of the drives A1 to A6 are connected to the power supply system V with the aid of a power distributor EV.

If the drive A1 of the drive group AG1 fails on account of a malfunction, the sensor G1 continues to transmit its actual values to the drive bus AB1. After detection of the malfunction of the drive A1, all the other drives A2, A3 involved, synchronize themselves immediately to the actual values of the drive A1 as transmitted by sensor G1. Thereafter, a system or subsystem standstill is initiated.

The synchronizing function of the faultlessly operating drives A2, A3 to the faulty drive A1 avoids the drives A1 to A3 running in disparity from one another. The faulty drive assumes a master functionality with its actual values being transmitted by the sensor G1.

Since the faulty drive A1 will inevitably run down, all the fault-free drives A2, A3 follow this rundown to the system or subsystem standstill. The synchronization of all the drives reduces or avoids incalculable states in the machine. Consequently, for example, damage to the machine is advantageously avoided.

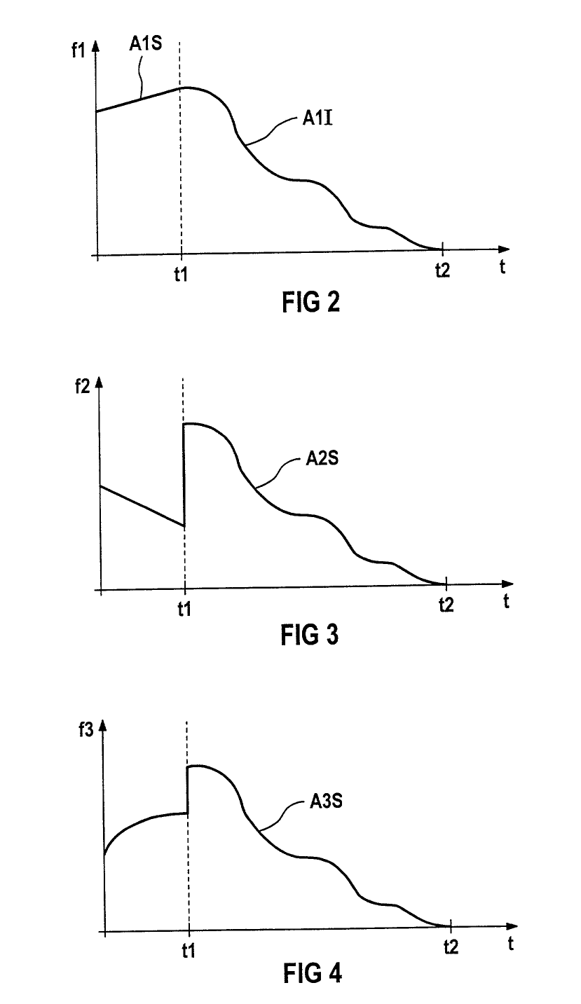

In FIG. 2 to FIG. 4, actual and nominal values of a faulty drive, along with nominal values of involved drives are represented. These are respectively assigned to a drive A1, A2 and A3 of a drive group AG1. An associated nominal rotational speed, is plotted on the respective Y axes, while the X axes represent time with the designation t.

Up to the depicted time t1, the respective drives A1 to A3 have a nominal speed, the respective profile of which can be seen in FIG. 2, FIG. 3 and FIG. 4. Up to the time t1, the drive A1 has the nominal speed characteristic A1S. A malfunction in the drive A1 at the time t1 leads to the drive A1 running down in an undefined way. The actual speed values of the drive A1 after failure at the time t1 are depicted in the representation according to FIG. 2 by A1I.

The malfunction of the drive A1 is detected in the system at the time t1 and all the other drives A2, A3 involved immediately convert their nominal speed A2S, A3S to the actual value characteristic A1I of the drive A1. This can be seen in the representations according to FIG. 3 and FIG. 4. Since the actual value information of the drive A1 is available in real time to the drive bus AB1 through the sensor G1 and the drive controller AR1, the drives A2, A3 can synchronously follow the variations in the actual speed A1I of the drive A1. At time t2, the system or subsystem standstill has been reached.

This procedure ensures that the drives A1 to A6 are synchronously coordinated with one another and consequently reduces an asynchronous running down or idling of the drives A1 to A6 in the event of a fault. Damage to the machine and material produced can be reduced or even avoided completely.

The use of a real-time Ethernet means that a standardized, widespread and universally usable bus protocol is used, making possible a high transmission capacity. On account of short bus cycles, measuring parameters and changes in the system state can be rapidly detected, so that rapid correction of deviations from nominal values can take place.

I claim:

1. A method of preventing damage to or by a machine having individual drives for machine elements, said drives being susceptible to operational faults, comprising exchanging process information in a technical process associated with said machines via at least one data link; initiating, a drive braking function and/or a system standstill after detection of a faulty drive; and transmitting actual values of the faulty drive as nominal values to faultlessly operating drives.

2. The method according to claim 1, further comprising changing the actual values of the faulty drive by at least one mathematical function according to process requirements.

3. The method according to claim 1, further comprising a real-time communication link as the data link.

4. The method according to claim 3, further comprising using a real-time Ethernet as the real-time data link.

5. A machine having individual drives for driving associated machine elements in a coordinated technical process, comprising at least one data link for exchanging process information, detector means for detecting a fault in at least one drive, braking and/or system standstill means, wherein actual values of a drive detected as having a fault are transmitted by a real-time Ethernet as nominal values to drives that are fault free.

6. The machine according to claim 5, wherein said machine is a printing machine.
